(19) United States
(12) Patent Application Publication
(10) Pub. No.: US 2026/0227919 A1
(43) Pub. Date: Aug. 6, 2026

(54) Managing Namespaces Across Logical Groups in a Data Storage Array

(71) Applicant: Western Digital Technologies, Inc., San Jose, CA (US)

(72) Inventors: Sridhar Sabesan, Bangalore (IN); Dinesh Babu, Bangalore (IN); Pavan Gururaj, Bangalore (IN)

(21) Appl. No.: 19/037,949

(22) Filed: Jan. 27, 2025

(51) Int. Cl. G06F 3/06

(52) U.S. Cl. CPC G06F 3/0631; G06F 3/0604; G06F 3/0616; G06F 3/0688

(57) ABSTRACT

Systems, methods, and network interface controllers for managing namespaces across logical groups, such as domains and endurance groups for non-volatile memory express (NVMe) systems, in a data storage array are described. The data units in the data storage devices of a storage array may be allocated to namespaces under a logical group hierarchy that includes domains and endurance groups. A global identifier and corresponding mapping reference data structure may be implemented in the host or network interface controller to allow the host to allocate and use namespaces that span these logically separated groups. Each time the host processes a host storage command, the global identifier reference may be used to locate allocated data units and path information for sending that host storage command.

### TECHNICAL FIELD

The present disclosure generally relates to managing namespaces in data storage device arrays and, more particularly, to extending namespaces across protocol-defined domains and endurance groups.

### BACKGROUND

Data storage systems have evolved to handle increasingly complex storage requirements across distributed environments. Modern storage arrays often utilize multiple data storage devices, generally disk drives (solid-state drives (SSD), hard disk drives (HDD), hybrid drives, tape drives, etc.), and protocols to manage data across various logical groups and namespaces. These systems aim to provide efficient data access while maintaining data integrity and optimizing resource utilization. In some configurations, host systems may utilize multiple data storage arrays and their component data storage devices, while still desiring to control data placement across a vast pool of data units to support specific applications, such as machine learning.

An increasingly popular storage protocol for managing large data pools is non-volatile memory express (NVMe), which supports Flexible Data Placement (FDP) to provide enhanced host control over data placement and management in SSDs. Some features of FDP protocols and the logical group hierarchy it supports include:

Domains: FDP allows isolation of portions of storage systems based on defining different domains for organization reclaim units.

Endurance Groups (EGs): FDP allows the organization of storage into Endurance Groups, which are collections of media units with similar endurance characteristics Each EG may have its own set of attributes and wear leveling pool.

Reclaim Groups (RGs): EDP allows the organization of reclaim units within endurance groups into groups for cashier management.

Reclaim Units (RUs): Within EGs, storage is further divided into Reclaim Units. RUs may represent the minimum unit of storage that can be erased and reallocated independently. Reclaim units may correspond to erase block in the individual SSDs.

The FDP features may allow hosts to have more direct control over where data is placed within the SSD, potentially enabling optimizations for specific workloads or data types. By giving hosts more control over data placement, FDP may help reduce write amplification in certain scenarios. Namespaces may be created and have reclaim units allocated to them based on the hierarchy of logical groups defined by the protocol within a domain and endurance group. FDP may allow for dynamic reconfiguration of endurance groups enabling adaptability to changing workloads. Current implementations use domains and endurance groups to provide isolation between different data streams or tenants by allowing them to be assigned to separate domains or endurance groups. FDP may aim to provide storage administrators and applications with more granular control over SSD resources, potentially leading to improved performance, endurance, and quality of service in multi-tenant or mixed-workload environments.

As storage demands grow, there is a need for improved methods of managing namespaces and data allocation across logically separated groups in storage arrays. Existing approaches may be limited in their ability to flexibly assign data units from multiple logical groups to a single namespace. Additionally, current systems may struggle to efficiently track and access data that spans across protocol-defined boundaries like endurance groups or domains. Addressing these challenges could enhance the scalability and performance of multi-device storage systems.

Therefore, there still exists a need for storage systems capable of flexibly assigning data units from multiple logical groups to a single namespace across protocol-defined boundaries like endurance groups or domains.

### SUMMARY

Various aspects for managing namespaces across protocol-isolated logical groups, such as domains and endurance groups, in data storage arrays are described. More particularly, global identifiers (GIDs) may be defined that span domains and/or endurance groups and be supported by a GID mapping data structure that spans the protocol-defined hierarchy to provide hosts with the flexibility to manage namespaces and allocate storage commands across domains and/or endurance groups.

One general aspect includes a system that includes a storage interface configured for communication with a plurality of data storage devices using a storage protocol, where each data storage device of the plurality of data storage devices may include a non-volatile storage medium configured to allocate data units to at least one namespace. The system also includes at least one processor configured to, alone or in combination: determine, for each data storage device of the plurality of data storage devices, a device set of data units in that data storage device, where the device set of data units are configured to be allocated across a plurality of logically separated groups by the storage protocol; determine a global identifier for at least one namespace in the plurality of data storage devices; assign a namespace set of data units to the global identifier, where the namespace set of data units may include data units from a plurality of logically separated groups; determine, for a target namespace of the at least one namespace for a host storage command, a corresponding global identifier; and send, based on the corresponding global identifier and through the storage interface, the host storage command targeting data units in the target namespace.

Implementations may include one or more of the following features. The logically separated groups may include at least one group defined by the storage protocol and selected from: endurance groups configured to exclusively allocate a plurality of data units assigned to that endurance group; and domains configured to exclusively allocate a plurality of endurance groups assigned to that domain. The storage protocol may be configured to: exclusively allocate each data unit in the plurality of data storage devices among a plurality of resource groups; and exclusively allocate each resource group of the plurality of resource groups among a plurality of endurance groups. The system may include a non-volatile memory configured to store a reference data structure comprising a matrix of: data storage device identifiers corresponding to the plurality of data storage devices; and namespace identifiers corresponding to the at least one namespace, where each node of the matrix stores a data unit allocation value for that combination of data storage device and namespace. The global identifier may correspond to a multi-level hierarchy of hierarchical identifiers corresponding to the logically separated groups; and the data unit allocation value may include at least one hierarchical identifier for each level of the multi-level hierarchy configured to uniquely map the data units in a target namespace across the plurality of data storage device according to the multi-level hierarchy. The data unit allocation value may include: a placement identifier corresponding to a domain defined by the storage protocol; and a reclaim unit handle identifier corresponding to an endurance group defined by the storage protocol. The global identifier may be configured to be a first global identifier in a first layer of a multi-level global identifier hierarchy; and the first layer of multi-level global identifiers may correspond to namespace global identifiers mapped to a set of namespaces and data storage devices. The multi-level global identifier hierarchy may include: master global identifiers corresponding to initiator systems defined by the storage protocol; and child global identifiers corresponding to target subsystems defined by the storage protocol. The at least one processor may be further configured to, alone or in combination: determine a host storage operation for the host storage command; access, using the global identifier and the target namespace, a reference data structure to determine at least one data unit allocation value and corresponding data storage device identifier; select target data units for the host storage command; and populate, in accordance with the storage protocol, the host storage command using the data unit allocation value and data unit identifiers for the target data units. The system may include a network interface card configured for offloading the storage protocol from a host system that includes: the storage interface; the at least one processor; and a non-volatile memory configured to store a reference data structure mapping the global identifier to the at least one namespace, the plurality of data storage devices, and corresponding data path information for the storage protocol. The system may include a network switch configured to be communicatively coupled between the network interface card and the plurality of data storage devices.

Another general aspect includes a computer-implemented method that includes: establishing, through a storage interface, communication between a host system and a plurality of data storage devices using a storage protocol, where each data storage device of the plurality of data storage devices may include a non-volatile storage medium configured to allocate data units to at least one namespace; determining, for each data storage device of the plurality of data storage devices, a device set of data units in that data storage device, where the device set of data units are configured to be allocated across a plurality of logically separated groups by the storage protocol; determining a global identifier for at least one namespace in the plurality of data storage devices; assigning a namespace set of data units to the global identifier, where the namespace set of data units may include data units from a plurality of logically separated groups; determining, for a target namespace of the at least one namespace for a host storage command, a corresponding global identifier; and send, based on the corresponding global identifier and through the storage interface, the host storage command targeting data units in the target namespace.

Implementations may include one or more of the following features. The logically separated groups may include at least one group defined by the storage protocol and selected from: endurance groups configured to exclusively allocate a plurality of data units assigned to that endurance group; and domains configured to exclusively allocate a plurality of endurance groups assigned to that domain. The storage protocol may be configured to: exclusively allocate each data unit in the plurality of data storage devices among a plurality of resource groups; and exclusively allocate each resource group of the plurality of resource groups among a plurality of endurance groups. The computer-implemented method may further include: storing, in a non-volatile memory, a reference data structure comprising a matrix of data storage device identifiers corresponding to the plurality of data storage devices and namespace identifiers corresponding to the at least one namespace, where each node of the matrix stores a data unit allocation value for that combination of data storage device and namespace; and accessing the reference data structure to determine the data unit allocation value for sending the host storage command. The global identifier may correspond to a multi-level hierarchy of hierarchical identifiers corresponding to the logically separated groups; and the data unit allocation value may include at least one hierarchical identifier for each level of the multi-level hierarchy configured to uniquely map the data units in a target namespace across the plurality of data storage device according to the multi-level hierarchy. The data unit allocation value may include: a placement identifier corresponding to a domain defined by the storage protocol; and a reclaim unit handle identifier corresponding to an endurance group defined by the storage protocol. The global identifier may be configured to be a first global identifier in a first layer of a multi-level global identifier hierarchy; and the first layer of multi-level global identifiers may correspond to namespace global identifiers mapped to a set of namespaces and data storage devices. The multi-level global identifier hierarchy may include: master global identifiers corresponding to initiator systems defined by the storage protocol; and child global identifiers corresponding to target subsystems defined by the storage protocol. The computer-implemented method may include: determining a host storage operation for the host storage command; accessing, using the global identifier and the target namespace, a reference data structure to determine at least one data unit allocation value and corresponding data storage device identifier; selecting target data units for the host storage command; and populating, in accordance with the storage protocol, the host storage command using the data unit allocation value and data unit identifiers for the target data units.

Still another general aspect includes a system that includes: at least one processor; at least one memory; a storage interface configured for communication with a plurality of data storage devices using a storage protocol, where each data storage device of the plurality of data storage devices may include a non-volatile storage medium configured to allocate data units to at least one namespace; means for determining, for each data storage device of the plurality of data storage devices, a device set of data units in that data storage device, where the device set of data units are configured to be allocated across a plurality of logically separated groups by the storage protocol; means for determining a global identifier for at least one namespace in the plurality of data storage devices; means for assigning a namespace set of data units to the global identifier, where the namespace set of data units may include data units from a plurality of logically separated groups; means for determining, for a target namespace of the at least one namespace for a host storage command, a corresponding global identifier; and means for send, based on the corresponding global identifier and through the storage interface, the host storage command targeting data units in the target namespace.

The various embodiments advantageously apply the teachings of data storage devices and/or multi-device storage systems to improve the functionality of such computer systems. The various embodiments include operations to overcome or at least reduce the issues previously encountered in storage arrays and/or systems and, accordingly, are more reliable and/or efficient than other computing systems. That is, the various embodiments disclosed herein include hardware and/or software with functionality to improve host management of data placement using namespaces that span protocol-isolated logical groups, such as by using a global identifier that maps the data unit allocations based on the protocol hierarchy to individual drives and namespaces. Accordingly, the embodiments disclosed herein provide various improvements to storage networks and/or storage systems.

It should be understood that language used in the present disclosure has been principally selected for readability and instructional purposes, and not to limit the scope of the subject matter disclosed herein.

### BRIEF DESCRIPTION OF THE DRAWINGS

FIG. 1 schematically illustrates a multi-device storage system supporting a plurality of host systems.

FIG. 2a schematically illustrates prior art namespace allocations limited by endurance group isolation.

FIG. 2b schematically illustrates namespace allocations across endurance groups.

FIG. 3 schematically illustrates a storage node of the multi-device storage system of FIG. 1.

FIG. 4 schematically illustrates a host node of the multi-device storage system of FIG. 1.

FIG. 5 schematically illustrates some elements of the storage system of FIG. 1 in more detail.

FIG. 6 schematically illustrates a GID overlaying the protocol-defined hierarchy for allocating data units.

FIG. 7 schematically illustrates master and child GIDs for managing GIDs across multiple subsystems.

FIG. 8 is a flowchart of an example method of defining namespaces using GIDs and generating storage commands based on those GIDs.

FIG. 9 is a flowchart of an example method of allocating data units in a protocol hierarchy to a GID and then allocating that GID into a master/child GID management hierarchy.

### DETAILED DESCRIPTION

The present disclosure relates to systems and methods for managing data storage across multiple storage devices using global identifiers. In particular, the disclosure describes techniques for overcoming limitations in data placement across logical groups in storage systems that utilize flexible data placement (FDP) drives.

In some configurations, a storage system may include multiple data storage devices, each comprising non-volatile storage media configured to allocate data units to one or more namespaces. The storage system may implement a storage protocol that defines logically separated groups for organizing data units within the storage devices. These logically separated groups may include, for example, endurance groups and domains.

A global identifier system may be implemented to enable namespace creation across multiple logical groups, such as across multiple endurance groups or domains. This global identifier system may allow for more flexible data placement and storage allocation compared to traditional systems where namespaces are confined within individual logical groups isolated by the storage protocol.

The storage system may include a host system that maintains a mapping data structure. This mapping data structure may associate global identifiers with namespaces and data units across multiple storage devices and logical groups. By utilizing this mapping structure, the host system may manage data placement and access operations that span across traditional boundaries of logical groups.

In some configurations, the global identifier system may implement a hierarchical structure defined and supported by the storage protocol. This hierarchy may include multiple levels, such as placement identifiers, reclaim unit handles, and resource groups. The hierarchical structure may allow for granular control and organization of data units across the storage system.

The disclosed techniques may enable improved storage utilization and flexibility in data placement. For example, the system may allow for the creation of namespaces that span multiple endurance groups or domains, which may not be possible in traditional storage systems. This capability may be particularly useful in storage arrays and storage servers that manage large amounts of data across multiple drives. By implementing the global identifier system and associated mapping structures, the storage system may overcome limitations in current flexible data placement protocols. This may allow for more efficient use of storage resources and improved performance in various storage scenarios, including those involving large-scale data centers and cloud storage environments.

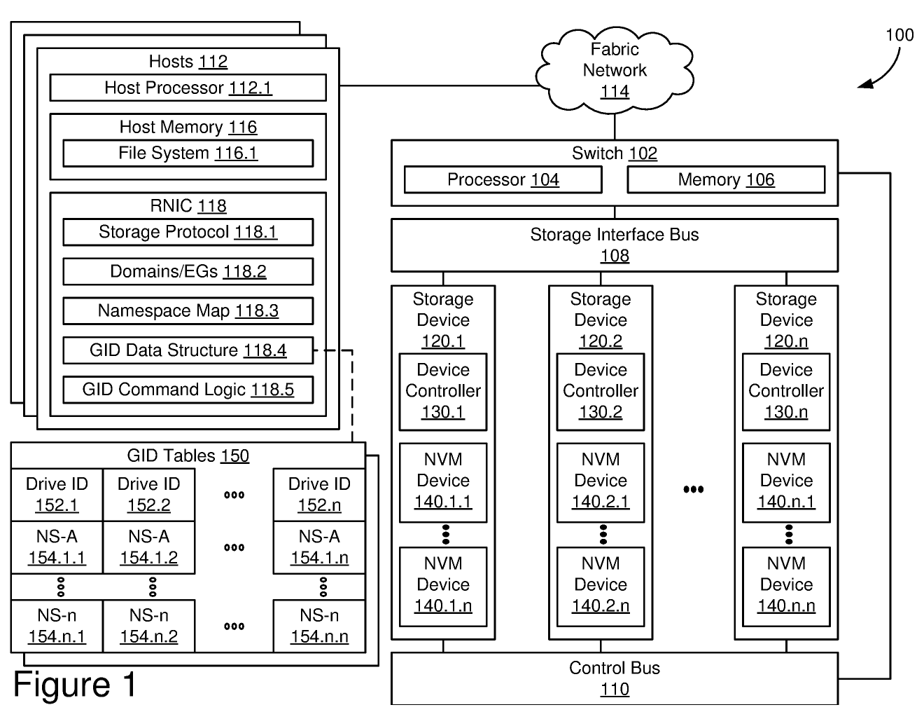

FIG. 1 shows an embodiment of an example data storage system 100 with multiple data storage devices 120 supporting a plurality of host systems 112 through switch 102. While some example features are illustrated, various other features have not been illustrated for the sake of brevity and so as not to obscure pertinent aspects of the example embodiments disclosed herein. To that end, as a non-limiting example, data storage system 100 may include one or more data storage devices 120 (also sometimes called information storage devices, storage devices, disk drives, or drives) configured in a storage node, such as a just-a-bunch-if-flash (JBOF), with switch 102. In some embodiments, storage devices 120 may be configured in a server, storage array blade, all flash array appliance, or similar storage unit for use in data center storage racks or chassis. Storage devices 120 may interface with one or more host nodes or host systems 112 and provide data storage and retrieval capabilities for or through those host systems. In some embodiments, storage devices 120 may be configured in a storage hierarchy that includes storage nodes, storage controllers, and/or other intermediate and/or network components between storage devices 120 and host systems 112. For example, each switch 102 may correspond to a set of storage devices 120 in a storage node and their respective storage devices may be connected through a corresponding backplane network or internal bus architecture including storage interface bus 108 and/or control bus 110, though only one instance of switch 102 and corresponding storage node components are shown. In some embodiments, switch 102 may include or be configured within a host bus adapter for connecting storage devices 120 to fabric network 114 for communication with host systems 112.

In the embodiment shown, a number of storage devices 120 are attached to a common storage interface bus 108 for host communication through switch 102. For example, storage devices 120 may include a number of drives arranged in a storage array, such as storage devices sharing a common rack, unit, or blade in a data center or the SSDs in an all-flash array. In some embodiments, storage devices 120 may share a backplane network, network switch(es), and/or other hardware and software components accessed through storage interface bus 108 and/or control bus 110. For example, storage devices 120 may connect to storage interface bus 108 and/or control bus 110 through a plurality of physical port connections that define physical, transport, and other logical channels for establishing communication with the different components and subcomponents for establishing a communication channel to host 112. In some embodiments, storage interface bus 108 may provide the primary host interface for storage device management and host data transfer, and control bus 110 may include limited connectivity to the host for low-level control functions. For example, storage interface bus 108 may support peripheral component interface express (PCIe) connections to each storage device 120 and control bus 110 may use a separate physical connector or extended set of pins for connection to each storage device 120.

In some embodiments, storage devices 120 may be referred to as a peer group or peer storage devices because they are interconnected through storage interface bus 108 and/or control bus 110. In some embodiments, storage devices 120 may be configured for peer communication among storage devices 120 through storage interface bus 108 and/or switch 102, with or without the assistance of host systems 112. For example, storage devices 120 may be configured for direct memory access using one or more protocols, such as non-volatile memory express (NVMe), remote direct memory access (RDMA), NVMe over fabric (NVMeOF), etc., to provide command messaging and data transfer between storage devices using the high-bandwidth storage interface and storage interface bus 108.

In some embodiments, data storage devices 120 are, or include, solid-state drives (SSDs). Each data storage device 120.1-120.n may include a non-volatile memory (NVM) or device controller 130 based on compute resources (processor and memory) and a plurality of NVM or media devices 140 for data storage (e.g., one or more NVM device(s), such as one or more flash memory devices). In some embodiments, a respective data storage device 120 of the one or more data storage devices includes one or more NVM controllers, such as flash controllers or channel controllers (e.g., for storage devices having NVM devices in multiple memory channels). In some embodiments, data storage devices 120 may each be packaged in a housing, such as a multi-part sealed housing with a defined form factor and ports and/or connectors for interconnecting with storage interface bus 108 and/or control bus 110.

In some embodiments, a respective data storage device 120 may include a single medium device while in other embodiments the respective data storage device 120 includes a plurality of media devices. In some embodiments, media devices include NAND-type flash memory or NOR-type flash memory. In some embodiments, data storage device 120 may include one or more hard disk drives (HDDs). In some embodiments, data storage devices 120 may include a flash memory device, which in turn includes one or more flash memory die, one or more flash memory packages, one or more flash memory channels or the like. However, in some embodiments, one or more of the data storage devices 120 may have other types of non-volatile data storage media (e.g., phase-change random access memory (PCRAM), resistive random access memory (ReRAM), spin-transfer torque random access memory (STT-RAM), magneto-resistive random access memory (MRAM), etc.).

In some embodiments, each storage device 120 includes a device controller 130, which includes one or more processing units (also sometimes called central processing units (CPUs), processors, microprocessors, or microcontrollers) configured to execute instructions in one or more programs. In some embodiments, the one or more processors are shared by one or more components within, and in some cases, beyond the function of the device controllers. In some embodiments, device controllers 130 may include firmware for controlling data written to and read from media devices 140, one or more storage (or host) interface protocols for communication with other components, as well as various internal functions, such as garbage collection, wear leveling, media scans, and other memory and data maintenance. For example, device controllers 130 may include firmware for running the NVM layer of an NVMe storage protocol alongside media device interface and management functions specific to the storage device. Media devices 140 are coupled to device controllers 130 through connections that typically convey commands in addition to data, and optionally convey metadata, error correction information and/or other information in addition to data values to be stored in media devices and data values read from media devices 140. Media devices 140 may include any number (i.e., one or more) of memory devices including, without limitation, non-volatile semiconductor memory devices, such as flash memory device(s).

In some embodiments, media devices 140 in storage devices 120 are divided into a number of addressable and individually selectable blocks, sometimes called erase blocks. In some embodiments, individually selectable blocks are the minimum size erasable units in a flash memory device. In other words, each block contains the minimum number of memory cells that can be erased simultaneously (i.e., in a single erase operation). Each block is usually further divided into a plurality of pages and/or word lines, where each page or word line is typically an instance of the smallest individually accessible (readable) portion in a block. In some embodiments (e.g., using some types of flash memory), the smallest individually accessible unit of a data set, however, is a sector or codeword, which is a subunit of a page. That is, a block includes a plurality of pages, each page contains a plurality of sectors or codewords, and each sector or codeword is the minimum unit of data for reading data from the flash memory device.

A data unit may describe any size allocation of data, such as host block, data object, sector, page, multi-plane page, erase/programming block, media device/package, etc. Storage locations may include physical and/or logical locations on storage devices 120 and may be described and/or allocated at different levels of granularity depending on the storage medium, storage device/system configuration, and/or context. For example, storage locations may be allocated at a host logical block address (LBA) data unit size and addressability for host read/write purposes but managed as pages with storage device addressing managed in the media flash translation layer (FTL) in other contexts. Media segments may include physical storage locations on storage devices 120, which may also correspond to one or more logical storage locations. In some embodiments, media segments may include a continuous series of physical storage location, such as adjacent data units on a storage medium, and, for flash memory devices, may correspond to one or more media erase or programming blocks. A logical data group may include a plurality of logical data units that may be grouped on a logical basis, regardless of storage location, such as data objects, files, or other logical data constructs composed of multiple host blocks.

In some embodiments, switch 102 may be coupled to data storage devices 120 through a network interface that is part of host fabric network 114 and includes storage interface bus 108 as a host fabric interface. In some embodiments, host systems 112 are coupled to data storage system 100 through fabric network 114 and switch 102 may include or be integrated in a storage network interface, host bus adapter, or other interface capable of supporting communications with multiple host systems 112. Fabric network 114 may include a wired and/or wireless network (e.g., public and/or private computer networks in any number and/or configuration) which may be coupled in a suitable way for transferring data. For example, the fabric network may include any means of a conventional data communication network such as a local area network (LAN), a wide area network (WAN), a telephone network, such as the public switched telephone network (PSTN), an intranet, the internet, or any other suitable communication network or combination of communication networks. From the perspective of storage devices 120, storage interface bus 108 may be referred to as a host interface bus and provides a host data path between storage devices 120 and host systems 112, through switch 102 and/or an alternative interface to fabric network 114.

Host systems 112, or a respective host in a system having multiple hosts, may be any suitable computer device, such as a computer, a computer server, a laptop computer, a tablet device, a netbook, an internet kiosk, a personal digital assistant, a mobile phone, a smart phone, a gaming device, or any other computing device. Host systems 112 are sometimes called a host, client, or client system. In some embodiments, host systems 112 are server systems, such as a server system in a data center. In some embodiments, the one or more host systems 112 are one or more host devices distinct from a storage node housing the plurality of storage devices 120 and/or switch 102. In some embodiments, host systems 112 may include a plurality of host systems owned, operated, and/or hosting applications belonging to a plurality of entities and supporting one or more quality of service (QoS) standards for those entities and their applications. Host systems 112 may be configured to store and access data in the plurality of storage devices 120 in a multi-tenant configuration with shared storage resource pools accessed through namespaces and corresponding host connections to those host connections.

Host systems 112 may include one or more central processing units (CPUs) or host processors 112.1 for executing compute operations, storage management operations, and/or instructions for accessing storage devices 120, such as host storage commands, through fabric network 114. Processors 112.1 may include one or more processors or processor cores configured to operate alone or in combination to execute one or more functions described herein. Host systems 112 may include host memories 116 for storing instructions for execution by host processors 112.1, such as dynamic random access memory (DRAM) devices to provide operating memory for host systems 112. Host memories 116 may include any combination of volatile and non-volatile memory devices for supporting the operations of host systems 112. In some configurations, each host memory 116 may include a host file system 116.1 for managing host data storage to non-volatile memory. Host file system 116.1 may be configured in one or more volumes and corresponding data units, such as files, data blocks, and/or data objects, with known capacities and data sizes. Host file system 116.1 may use at least one storage driver to interface with a storage interface subsystem, such as a RDMA network interface card (RNIC) 118 to access storage resources. In some configurations, the storage interface subsystem may offload backend storage and communication protocols to enable the host file system to utilize some or all of the storage pool corresponding to storage devices 120 using a direct memory access storage protocol, such as NVMe.

RNIC 118 may be instantiated in a hardware interface card installed in a host system to interface between the host operating system (via a storage driver) and the storage pool of storage system 100. RNIC 118 may support one or more storage protocols 118.1 for interfacing with data storage devices, such as storage devices 120, and one or more network interface standards that can support storage protocol 118.1. RNIC 118 may integrate hardware and software support for on one or more interface standards, such as PCIe, ethernet, fiber channel, etc., to provide physical and transport connection through fabric network 114 to switch 102 and storage devices 120 and use a storage protocol over those standard connections to store and access host data stored in storage devices 120. In some configurations, storage protocol 118.1 may be based on defining isolated domains and/or endurance groups 118.2 for grouping and managing data units in storage devices 120. These isolated logical groups may be configured to operate independently to prevent data or operations from one logical group impacting another logical group and may include conflicting identifiers and/or duplicate hierarchical structures. Any given host may have access to multiple domains or endurance groups. However, standard protocols may require data stored in different domains or endurance groups to occupy mutually exclusive namespaces that do not overlay domains or endurance groups. RNIC 118 may include a namespace map or directory data structure indicating all available namespaces for a particular domain or endurance group. For example, discovery logs may provide namespace information for storage system 100 and be used by RNIC 118 to request host connections to target namespaces for executing host storage commands. Host connections may be requested by host systems 112 through RNIC 118 for accessing a namespace using queue pairs allocated in a host memory buffer and supported by a storage device instantiating at least a portion of that namespace.

To support flexible data allocation features within the storage protocol, a hierarchical logical structure exclusively allocates data units (reclaim units in NVMe) among resource groups, resource unit handles, and placement identifiers for ease of managing data placement. These hierarchies assist in allocating data to specific storage locations within a namespace, rather than allowing the storage controller or storage devices to select storage locations within the namespace based on host logical block addresses. The series of hierarchy identifiers, such as placement identifier (PID) and reclaim unit handle (RUH) may act as a storage path for identifying allocated reclaim units allocated in resource groups within a particular endurance group and domain.

RNIC 118 may be configured to use global identifiers (GIDs) that are unique across domains and/or endurance groups to enable host systems 112 to manage namespaces across endurance groups and/or domains. RNIC 118 may populate and maintain at least one GID data structure 118.4 including each GID used by host systems 112 and/or RNIC 118. An example GID mapping table 150 is shown in FIG. 1. GID mapping tables 150 may be defined and maintained for one or more GIDs. For each GID, GID table 150 may include a matrix of values that describe the allocation of data units across storage devices 120 and corresponding namespaces from namespace map 118.3. In the example shown, the top row corresponds to drive identifiers 152.1-152.n for storage devices 120.1-120.n. For each drive ID 152 corresponds to a column of namespace mapping values for the namespaces allocated in storage system 100, such as namespaces A-n that are each denoted by unique namespace identifiers. In some configurations, each row of mapping table 150 may correspond to a different namespace and namespace identifier in the namespace set for that set of devices and/or corresponding GID. For each combination of namespace identifier and drive identifier, corresponding namespace mapping values 154.1.1-154.n.n indicate a series of hierarchical identifiers for the data units allocated to that combination of namespace and storage device. For example, each mapping value may be a data unit allocation value in the format PID, RUH ID for that node of the matrix. By accessing GID mapping tables 150 for a target GID and namespace, RNIC 118 may determine eligible data units in one or more storage devices 120 based on the PIDs and RUHs in the corresponding mapping values.

RNIC 118 may include GID command logic for using the mapping information from GID tables 150 to populate host storage commands for storage protocol 118.1 using the mapping values. For example, when host systems 112 generate a storage operation for a target namespace, RNIC 118 may use an associated GID to index GID data structure 118.4 and locate the set of mapping values for that namespace across storage devices 120. RNIC 118 may then apply or translate the data placement logic from host systems 112 to select target data units for the storage operation. The host storage command from command logic 118.5 may use the corresponding PID and RUH ID values to direct the storage command to the selected reclaim group and/or reclaim units for the namespace in one or more storage devices 120.

Switch 102 may include one or more central processing units (CPUs) or processors 104 for directing commands and responses for accessing storage devices 120 through storage interface bus 108. This may include both host storage commands and administrative commands to storage devices 120. In some embodiments, processors 104 may include a plurality of processors or processor cores which may be assigned or allocated to parallel processing tasks and/or processing threads for different storage operations and/or host storage connections. Each processor or processor core may operate alone or in combination to execute its allotted function. In some embodiments, processor 104 may be configured to execute fabric interface for communications through fabric network 114 and/or storage interface protocols for communication through storage interface bus 108 and/or control bus 110. Switch 102 may also include a memory 106 configured to support the storage command routing and other functions of switch 102. In some embodiments, memory 106 may include one or more DRAM devices for operating memory for processor 104 and/or use by storage devices 120 for command, management parameter, and/or host data storage and transfer. In some embodiments, a separate network interface unit and/or storage interface unit (not shown) may provide the network interface protocol and/or storage interface protocol and related processor and memory resources. In some embodiments, storage devices 120 may be configured for direct memory access (DMA), such as using RDMA protocols, over storage interface bus 108.

In some embodiments, data storage system 100 includes one or more processors, one or more types of memory, a display and/or other user interface components such as a keyboard, a touch screen display, a mouse, a track-pad, and/or any number of supplemental devices to add functionality. In some embodiments, data storage system 100 does not have a display and other user interface components.

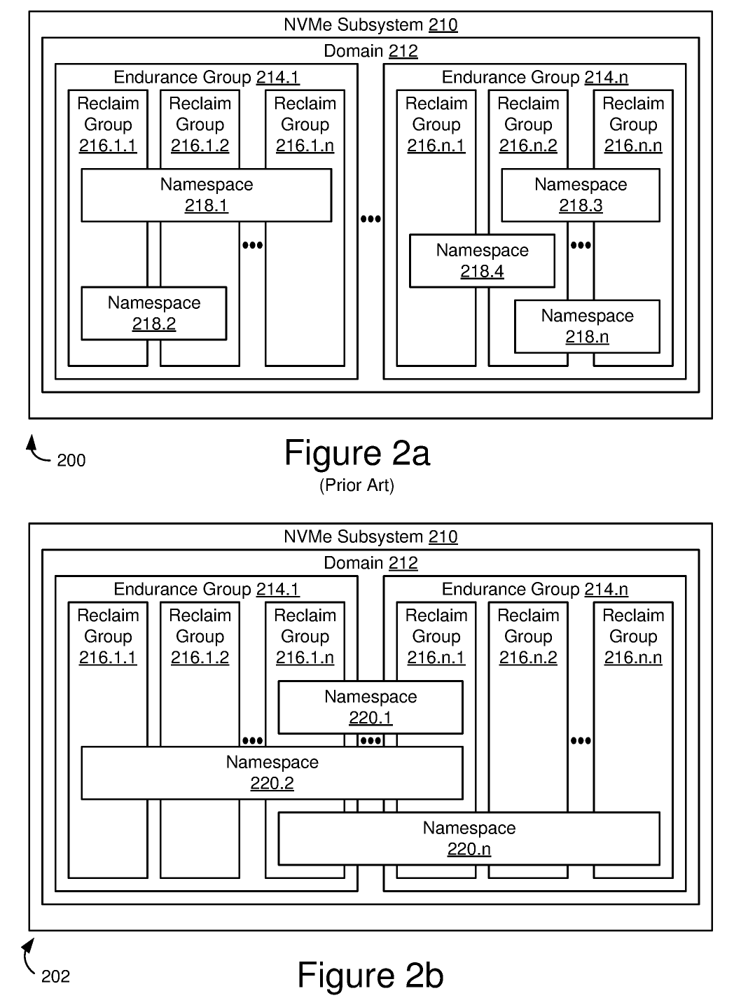

FIGS. 2a and 2b show schematic diagrams of different approaches to defining namespaces in a storage subsystem. In the prior art namespace configuration of FIG. 2a, namespaces were confined to a single endurance group within a storage domain, limiting flexibility and potentially impacting performance. For example, in a storage diagram 200, a storage subsystem 210 may include a storage domain 212 with multiple endurance groups, such as a first endurance group 214.1 and an nth endurance group 214.n. Each endurance group may contain multiple reclaim groups, such as a first reclaim group in first endurance group 216.1.1, a second reclaim group in first endurance group 216.1.2, and an nth reclaim group in first endurance group 216.1.n. In this configuration, namespaces such as a first namespace 218.1, a second namespace 218.2, a third namespace 218.3, a fourth namespace 218.4, and an nth namespace 218.n may be confined within individual endurance groups.

FIG. 2b shows an improved configuration where namespaces can span across multiple endurance groups. This enhancement allows for more efficient resource allocation and improved system adaptability. In storage diagram 202, storage subsystem 210 may maintain the same basic hierarchy with storage domain 212 containing endurance groups 214.1 and 214.n, each with their respective reclaim groups. However, in this configuration, namespaces may be implemented to span across different endurance groups, such as a first namespace 220.1 across endurance groups 214.1 and 214.n, a second namespace 220.2 across endurance groups 214.1 and 214.n, and an nth namespace 220.n across endurance groups 214.1 and 214.n.

As illustrated in FIGS. 2a and 2b, the prior art configuration shows isolated namespaces within individual endurance groups, while the improved configuration demonstrates namespaces extending across multiple endurance groups, visually emphasizing the expanded flexibility and resource utilization. In some cases, storage system 100 may implement this improved configuration to enable more efficient data placement and use of storage resources across storage devices 120. RNIC 118 may manage these cross-endurance group namespaces, potentially improving communication efficiency through the fabric network 114.

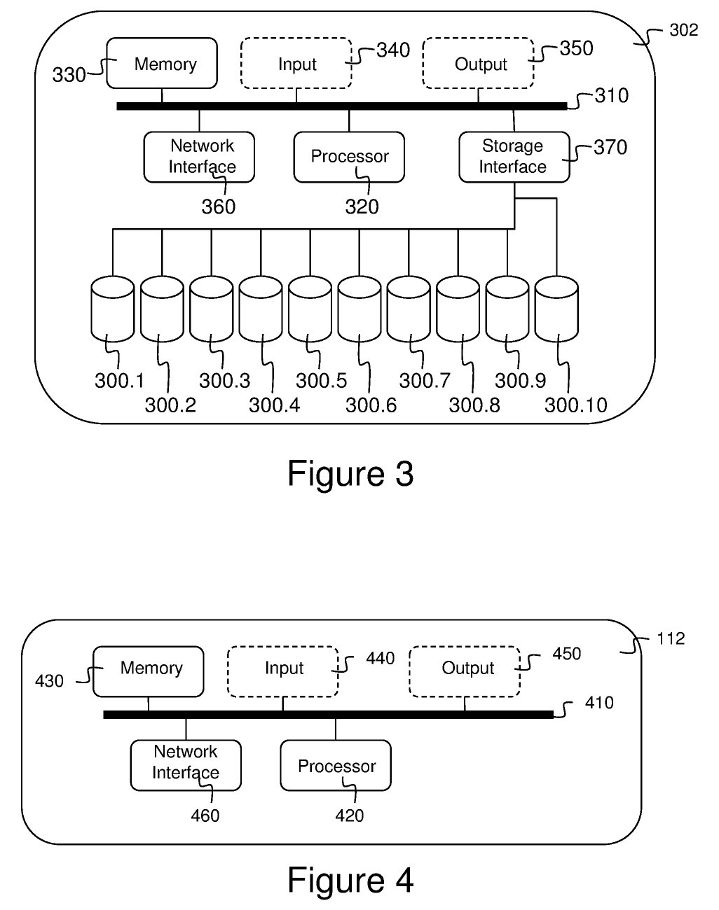

FIG. 3 shows a schematic representation of a storage node 302. For example, switch 102 may be configured as a storage node 302 for accessing storage devices 120 as storage elements 300. Storage node 302 may comprise a bus 310, a storage node processor 320, a storage node memory 330, one or more optional input units 340, one or more optional output units 350, a communication interface 360, a storage element interface 370 and a plurality of storage elements 300.1-300.10. In some embodiments, at least portions of bus 310, processor 320, local memory 330, communication interface 360, storage element interface 370 may comprise a storage controller, backplane management controller, network interface controller, or host bus interface controller. Bus 310 may include one or more conductors that permit communication among the components of storage node 302. Processor 320 may include any type of conventional processor or microprocessor that interprets and executes instructions. Local memory 330 may include a random-access memory (RAM) or another type of dynamic storage device that stores information and instructions for execution by processor 320 and/or a read only memory (ROM) or another type of static storage device that stores static information and instructions for use by processor 320. Input unit 340 may include one or more conventional mechanisms that permit an operator to input information to said storage node 302, such as a keyboard, a mouse, a pen, voice recognition and/or biometric mechanisms, etc. Output unit 350 may include one or more conventional mechanisms that output information to the operator, such as a display, a printer, a speaker, etc. Communication interface 360 may include any transceiver-like mechanism that enables storage node 302 to communicate with other devices and/or systems, for example mechanisms for communicating with other storage nodes 302 or host systems 112. Storage element interface 370 may comprise a storage interface, such as a Serial Advanced Technology Attachment (SATA) interface, a Small Computer System Interface (SCSI), PCIe, etc., for connecting bus 310 to one or more storage elements 300, such as one or more storage devices 120. For example, storage elements 300 may include 2 terabyte (TB) NVMe solid state drives (SSDs. As shown in FIG. 3, such a storage node 302 could comprise ten 2TB NVMe SSDs as storage elements 300.1-300.10 and in this way storage node 302 would provide a storage capacity of 20TB to storage system 100.

Storage elements 300 may be configured as redundant or operate independently of one another. In some configurations, if one particular storage element 300 fails its function can easily be taken on by another storage element 300 in the storage system. Furthermore, the independent operation of the storage elements 300 allows to use any suitable mix of types storage elements 300 to be used in a particular storage system 100. It is possible to use for example storage elements with differing storage capacity, storage elements of differing manufacturers, using different hardware technology such as for example conventional hard disks and solid-state storage elements, using different storage interfaces, and so on. All this results in specific advantages for scalability and flexibility of storage system 100 as it allows to add or remove storage elements 300 without imposing specific requirements to their design in correlation to other storage elements 300 already in use in that storage system 100.

FIG. 4 shows a schematic representation of an example host system 112. Host system 112 may comprise a bus 410, a processor 420, a local memory 430, one or more optional input units 440, one or more optional output units 450, and a communication interface 460. Bus 410 may include one or more conductors that permit communication among the components of host 112. Processor 420 may include any number and type of conventional processor or microprocessor that operate alone or in combination to interpret and execute instructions. Local memory 430 may include a random access memory (RAM) or another type of dynamic storage device that stores information and instructions for execution by processor 420 and/or a read only memory (ROM) or another type of static storage device that stores static information and instructions for use by processor 420 and/or any suitable storage element such as a hard disc or a solid state storage element. An optional input unit 440 may include one or more conventional mechanisms that permit an operator to input information to host 112 such as a keyboard, a mouse, a pen, voice recognition and/or biometric mechanisms, etc. Optional output unit 450 may include one or more conventional mechanisms that output information to the operator, such as a display, a printer, a speaker, etc. Communication interface 460 may include any transceiver-like mechanism that enables host 112 to communicate with other devices and/or systems. In some configurations, communication interface 460 may include one or more network interface cards, such as RNIC 118 and its associated functions.

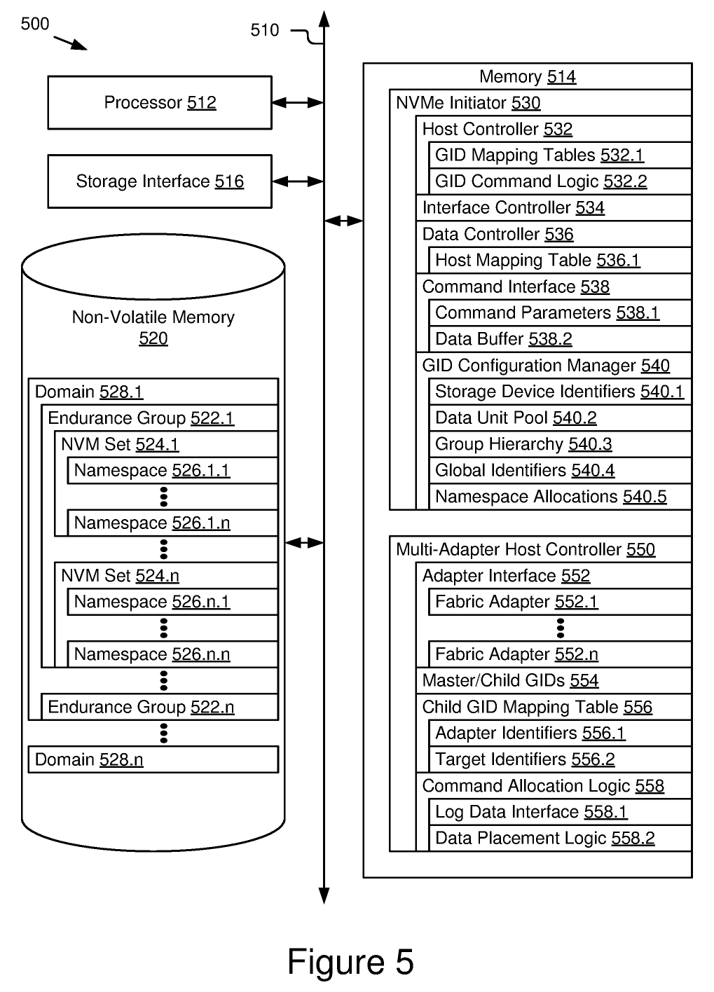

FIG. 5 schematically shows selected modules of a storage system 500 configured for using GIDs to manage namespaces across protocol-isolated logical groups like endurance groups and domains. Storage system 500 may incorporate elements and configurations similar to those shown in FIGS. 1, 2b, 3, and 4. For example, storage system 500 may be configured in an initiator system, such as hosts 112 or a storage controller or adapter in storage node 302, and a plurality of storage devices 120 supporting host connection requests and storage operations from host systems 112 over fabric network 114. In some embodiments, the functions of NVMe initiator 530 and/or multi-adapter host controller 550 may be instantiated in one or more initiator cards or subsystems in a host system and non-volatile memory 520 may correspond to the non-volatile memory of the data storage devices in the storage pool accessible to that host system.

Storage system 500 may include a bus 510 interconnecting at least one processor 512, at least one memory 514, and at least one interface, such as storage interface 516. Bus 510 may include one or more conductors that permit communication among the components of storage system 500. Processor 512 may include any number and type of processor or microprocessor configured to interprets and executes instructions or operations alone of in combination. Memory 514 may include a random access memory (RAM) or another type of dynamic storage device that stores information and instructions for execution by processor 512 and/or a read only memory (ROM) or another type of static storage device that stores static information and instructions for use by processor 512 and/or any suitable storage element such as a hard disk or a solid state storage element.

Storage interface 516 may include a physical interface for connecting to one or more data storage devices using an interface protocol that supports storage device access. For example, storage interface 516 may include a network interface and/or PCIe or similar storage interface connector supporting NVMe access to solid state media comprising non-volatile memory devices 520. In some configurations. storage interface 516 may include an ethernet connection to a host bus adapter, network interface, switch, or similar network interface connector supporting NVMe host connection protocols, such as RDMA and transmission control protocol/internet protocol (TCP/IP) connections. In some embodiments, storage interface 516 may support NVMeoF or similar storage interface protocols over one or more network communication protocols.

Storage system 500 may include a number of non-volatile memory devices 520 or similar storage elements configured to store host data in a non-volatile storage medium. For example, non-volatile memory devices 520 may include a plurality of SSDs or flash memory packages organized as an addressable memory array in one or more storage subsystems. In some configurations, non-volatile memory devices 520 may include NAND or NOR flash memory devices comprised of single level cells (SLC), multiple level cell (MLC), triple-level cells, quad-level cells, etc. Host data in non-volatile memory devices 520 may be organized according to a direct memory access storage protocol, such as NVMe, to support host systems storing and accessing data through logical host connections. In some configurations, non-volatile memory devices 520 may include host data accessed using flexible data placement features of the direct memory access storage protocol to allow the host system greater control over the physical data placement of data units in non-volatile memory devices 520. Non-volatile memory devices 520, such as the non-volatile memory devices of an array of SSDs, may be allocated to a plurality of namespaces 526 that may then be attached to one or more host systems for host data storage and access. Namespaces 526 may be created with allocated capacities based on the number of namespaces and host connections supported by the storage device. In some configurations, namespaces may be grouped in non-volatile memory sets 524, endurance groups 522, and/or domains 528. These logical groupings may be configured for the storage device based on the physical configuration of non-volatile memory devices 520 to support efficient allocation and use of memory locations. These groupings may also be hierarchically organized as show, with domains 528 including endurance groups 522 including NVM sets 524 that include namespaces 526. In some configurations, endurance groups 522 and domains 528 may be defined to within the storage protocol to be logically isolated such that NVM sets 524 and namespaces 526 do not span multiple endurance groups 522 or domains 528. NVMe initiator 530 may overlay a GID structure on the protocol-isolated logical groups to enable namespaces 526 and/or groups of namespaces 526 organized as NVM sets to include data units in multiple endurance groups and/or domains. In some configurations, NVMe initiator 530 may use GIDs to manage a flexible data placement hierarchy across endurance groups and domains and/or multi-adapter host controller 550 may manage such data hierarchies across multiple initiator subsystems corresponding to multiple fabric adapters and NVMe subsystems.

Storage system 500 may include a plurality of modules or subsystems that are stored and/or instantiated in memory 514 for execution by processor 512 as instructions or operations. For example, memory 514 may include an NVMe initiator 530 configured to receive, process, and respond to host operating system storage operations to provide corresponding host connections and host storage commands to non-volatile memory devices 520. Memory 514 may include a multi-adapter host controller 550 configured to manage namespaces defined across multiple initiator subsystems (where each subsystem includes an instance of NVMe initiator 530).

NVMe initiator 530 may include hardware, interface protocols, and/or set of functions, parameters, and/or data structures for receiving, parsing, responding to, and otherwise managing storage operations from or in a host system for offloading the storage device interface and initiating host storage commands according to a storage protocol, such as NVMe. In some configurations, NVMe initiator 530 may include a plurality of hardware and/or software modules configured to use processor 512 and memory 514 to handle or manage defined operations of NVMe initiator 530. For example, NVMe initiator 530 may include a host controller 532, an interface controller 534, a data controller 536, a command interface 538, and/or a GID configuration manager 540.

NVMe initiator 530 may include a host controller 532 configured to interface with the host operating system for administrative management of NVMe initiator 530. In some configurations, host controller 532 may be configured to utilize processor 512 and memory 514 to execute logic for managing the GID features for managing namespaces across isolated logical groups. For example, host controller 532 may instantiate a GID mapping data structure, such as GID mapping tables 532.1 and include GID command logic 532.2 for using GIDs associated with host storage operations to modify command interface 538 for host storage commands to namespaces that span multiple endurance groups or domains. In some configurations, GID mapping tables 532.1 may include a data structure stored in non-volatile memory for managing the FDP mapping for each data storage device and namespace accessible to that host system. For example, GID mapping tables 532.1 may be structured as described above with regard to GID tables 150 in FIG. 1. In some configurations, GID command logic 532.2 may include logic for mapping storage operations based on GID and namespace according meet storage protocol command standards. This may include implementing vendor specific parameters for those commands to include GID parameters in host storage commands and/or enabling translation of FDP parameters from GID mapping tables 532.1 into standard parameters sent to the target subsystem and/or data storage device. In some configurations, GID command logic 532.2 may interface with or integrate command allocation logic 558 for using the data placement mapping values from GID mapping tables 532.1 to select target data units in the target namespace. Host controller 532 may include or interface with GID configuration manager 540 for configuring and maintaining GID mapping tables 532.1 and GID command logic 532.2. In some configurations, host controller 532 may include additional functions, such as managing host connections and host connection requests, initializing and/or updating namespace mapping and/or NVMe directory logs, and otherwise managing administration of the host storage interface according to the storage interface protocols. Host controller 532 may be configured for interaction with a storage driver of the host system and enable the operating system of the host system to access non-volatile memory devices 520 as if they were local storage within the host systems. For example, connected namespaces in non-volatile memory devices 520 may appear as storage capacity within the host file system and defined volumes and data units managed by the host file system.

NVMe initiator 530 may include an interface controller 534 that includes and/or interface with storage interface 516 for the communication protocols to support network transport of the storage protocol. For example, storage interface 516 may include a network and/or PCIe interface and interface controller 534 may include the interface hardware and software to access storage interface 516 for sending host storage commands. Interface controller 534 may include functions passing host commands for both connection/device administration and reading, writing, modifying, or otherwise manipulating data blocks and their respective client or host data and/or metadata in accordance with storage interface protocols. In some configurations, interface controller 534 may enable direct memory access and/or access over NVMeoF protocols, such as RDMA and TCP/IP access, through storage interface 516 to host data units stored in non-volatile memory devices 520.

Data controller 536 may be configured to manage host data written to and retrieved from non-volatile memory 520 through NVMe initiator 530. For example, data controller 536 may operate in conjunction with host controller 532, command interface 538, and/or command allocation logic 558 to maintain host LBA mapping information for data written to and read from non-volatile memory 520. In some configurations, data controller 536 may include a data structure and corresponding memory allocation or hardware for maintaining a host mapping table 536.1. For example, host mapping table 536.1 may include host LBA or other addressing information used by the host operating system mapped to data placement information for those host data units. Host mapping table 536.1 may map host addressing information to data placement identifiers based on reclaim units and corresponding group hierarchy and may be accessed and modified as data placement decisions are made and host storage commands are processed by non-volatile memory devices 520. In some configurations, host mapping table 538.1 may be used to manage additional metadata related to host data units and/or their data placement mapping, such as usage, endurance, and log data.

Command interface 538 may include logic based on the storage protocol to assemble protocol-compliant host storage commands for sending through interface controller 534. For example, command interface 538 may receive command parameters 538.1 from host controller 532 and/or the storage driver of the host operating system and format them into NVMe compliant host storage commands according to protocol-defined syntax. In some configurations, command interface 538 may also manage a data buffer 538.2 and data allocations within that data buffer for locating the target data units for host storage commands. For example, the host operating system may write data to be written to data buffer 538.2 before it is sent to or accessed by the target data storage device executing the write command and/or receive data read from the data storage device executing a read command. In some configurations, data buffer 538.2 may operate in conjunction with or as a controller memory buffer configured for direct memory access through storage interface 516 for moving data between the host system and non-volatile memory devices 520.

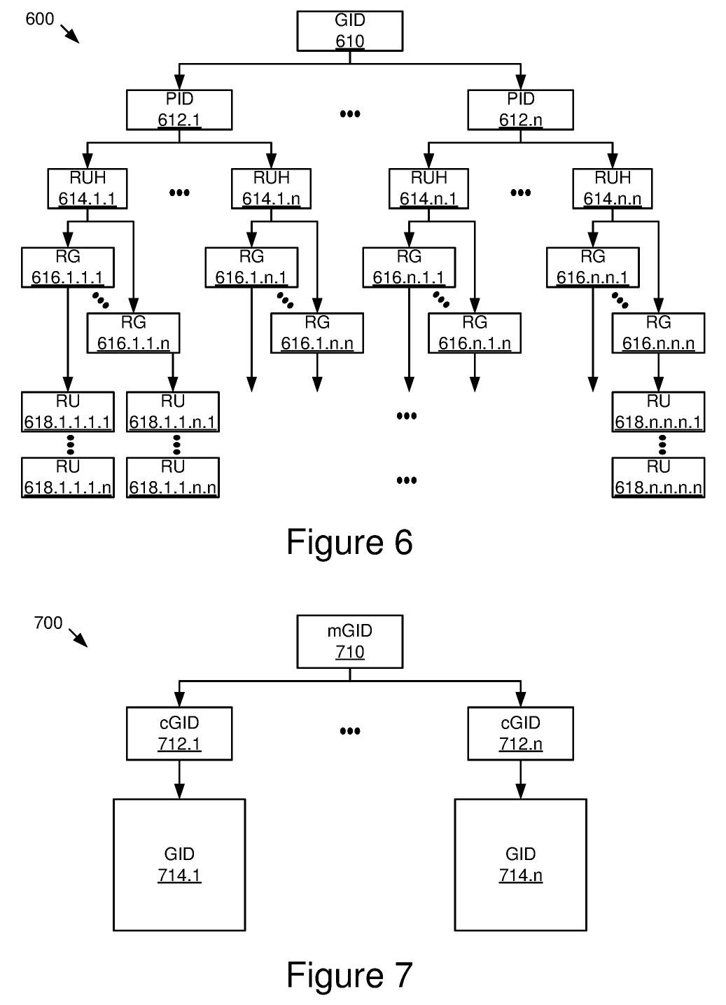

GID configuration manager 540 may include logic and interfaces for discovering and implementing namespace management using GIDs for overlaying protocol-defined data placement hierarchies. For example, GID configuration manager 540 may implement the protocol-defined data placement hierarchy for configuring GID mapping tables 532.1 and GID command logic 532.2. In some configurations, GID configuration manager 540 may also support data controller 436 fur using the data placement hierarchy and corresponding identifiers for mapping host data placements. GID configuration manager 540 may include storage device identifiers 540.1 corresponding to a data unit pool 540.2. For example, GID configuration manager 540 may be configured to receive and/or discover unique data storage device identifiers for each drive in non-volatile memory devices 520. In some configurations, GID configuration manager 540 may identify each data storage device and corresponding device type or configuration information describing the capacity and organization of data units within each data storage device. The aggregate data units available across the data storage devices may determine data unit pool 540.2 for organization into data placement groups and support of namespace allocations. GID configuration manager 540 may allocate the data unit pool according to a data placement group hierarchy defined by the flexible data placement features of the storage protocol. For example, GID configuration manager 540 may be configured with group hierarchy 540.3 that identifies a hierarchy of logical groups that are exclusively allocated such that each data unit belongs to only one logical group at each layer or level of the hierarchy. An example group hierarchy is further described below with regard to FIG. 6.

GID configuration manager 540 may implement a ser of global identifiers (GIDs) 540.4 for organizing the flexible data placement groups at a higher level that allows namespaces to be defined across data placement groups that are isolated from one another by the protocol, such as endurance groups and domains. GIDs 540.4 may effectively replace the endurance groups and domains for allocating data units such that only group hierarchy 540.3 defines the available data placements within a namespace. In some configurations, a single GID may be used to manage the data pool for each host system. In other configurations, the host system may implement multiple GIDs to enable selective (host-defined) isolation of logical data groups independent of endurance groups or domains. GID configuration manager 540 may include logic for generating and assigning GIDs 540.4. In some configurations, GID configuration manager 540 may include logic to allocate and maintain namespace allocations 540.5 to the one or more GIDs 540.4. For example, for each GID defined, namespace allocations 540.5 may identify the set of namespaces uniquely assigned to that global identifier. In some configurations, GID configuration manager 540 may use storage device identifiers 540.1 and namespace allocations 540.5 to populate and update GID mapping tables 532.1 for each GID. For example, as namespaces are created/allocated and/or data storage devices are added to data unit pool 540.2, the portions of those namespaces allocated to each data storage device may be defined in terms of group hierarchy 540.3 and stored in appropriate matrix entries in the GID mapping table for that GID. Managing group hierarchy 540.3 for GIDs 540.4 may allow the host to define namespaces and stripe data across multiple hierarchical groups, such as RUs, RGs, endurance groups, and domains. Data units may be selected to read and write data across multiple domains and NVMe subsystems. The GID provides a virtual layer to create and manage namespaces across different endurance groups and domains and enhance host system management and awareness of data patterns in the namespaces while maintaining a drive agnostic interface to the host operating system.

Multi-adapter host controller 550 may include hardware, interface protocols, and/or set of functions, parameters, and data structures for managing flexible data placement across a plurality of adapters, such as multiple NVMe initiators 530, for a host system. For example, multi-adapter host controller 550 may include interface logic and master/child GID functions for managing GIDs and data placements across multiple initiators and subsystems for a host system that supports multiple fabric adapters. In NVMeoF implementations, multiple hosts may talk to multiple subsystem targets (e.g., different JBOFs or similar target NVMe subsystems). Each host may have one or more fabric adapters with which to connect to different targets and corresponding sets of data storage devices and data unit pool. Each fabric adapter may be assigned a master GID (mGID) and each target subsystem may be assigned a child GID (cGID). These additional layers are further explained below with regard to FIG. 7. Multi-adapter host controller 550 may include a plurality of hardware and/or software modules configured to use processor 512 and memory 514 to handle or manage defined operations of multi-adapter host controller 550. For example, multi-adapter host controller 550 may include and/or access adapter interface 552, master/child GIDs 554, child GID mapping table 556, and/or command allocation logic 558.

Adapter interface 552 may include the host system interface to one or more fabric adapters 552.1-552.n. In some configurations, each fabric adapter 552 may be configured substantially as described above for NVMe initiator 530 and adapter interface 552 may include logic for identifying and managing the set of available adapters. Multi-adapter host controller 550 may assign a unique master and child GIDs 554 to each initiator or fabric adapter and target subsystem respectively. For example, each fabric adapter 552.1-552.n may have a corresponding unique mGID and each target subsystem may have a corresponding unique cGID. These unique identifiers may be assigned automatically by the system during initialization or provisioning of the adapters and targets and/or managed through administrative commands, such as a configuration manager similar to GID configuration manager 540 implemented at the host or system administrator level. Multi-adapter host controller 550 may include a master/child/system mapping data structure, such as child GID mapping table 556 that maps adapter identifiers 556.1 to mGIDs and target identifiers 556.2 to child identifiers. In some configurations, target identifiers may map directly to GIDs as described above with regard to similar single initiator and target subsystem configurations for NVMe initiator 530. In some configurations, multiple adapters may be supported by host-side logic embodying shared functions of host controller 532 and/or GID configuration manager 540. This host side logic may be embodied in a storage driver and/or application layer utility for managing multiple GIDs, including corresponding master and child GIDs.

Command allocation logic 558 may include host logic for allocating host storage operations across one or more data pools. While command allocation logic 558 is shown as a subcomponent of multi-adapter host controller 550 and may be embodied in an NVMeoF management utility or storage driver specifically for multi-adapter implementations, similar logic may be implemented in individual host system utilities or storage drivers and/or NVMe initiator 530 for managing data placement for those storage systems. Command allocation logic 558 may include any set of data unit selection logic for managing data placement to a storage pool using flexible data placement features. For example, host systems may have command allocation logic that uses the logical group hierarchy of the available data pool and operational knowledge of the applications supported by the host system to determine how data storage loads are distributed among the available data units. In some configurations, command allocation logic 558 may include a log data interface 558.1 configured to receive, access, and/or aggregate log data from storage operations, storage subsystems, and/or data storage devices supporting the data unit pool. For example, flexible data placement drives may provide log statistics, such as unused reclaim groups, written reclaim groups, read/write statistics (load, queue depths, processing time, etc.), log pages for reclaim units, and similar data for data placement decision-making. Data placement logic 558.2 may include logic for selecting target data placements for a specific storage operation and corresponding host storage commands. For example, data placement logic 558.2 may use one or more load balancing, endurance, data priority, service level, security, etc. criteria for selecting among possible reclaim units in the storage pool for each host storage command.

As shown in FIG. 6, storage system 500 may implement a global identifier hierarchy 600 for organizing and managing data units across multiple storage devices. The global identifier hierarchy 600 may include multiple levels of logical groups and corresponding hierarchical identifiers that exclusively allocate data units from the data unit pool 540.2. At the top level of the global identifier hierarchy 600, a global identifier (GID) 610 may be defined. Global identifier 610 may correspond to a set of namespaces and data storage devices managed by the storage system 500. In some configurations, global identifier 610 may be implemented in a data structure containing mapping information for all drives in the system, similar to the GID mapping tables 532.1.

Global identifier 610 may branch into multiple placement identifiers, including a first placement identifier 612.1 through an nth placement identifier 612.n in a next level of the hierarchy. In some configurations, each placement identifier may correspond to a domain defined by the storage protocol. The placement identifiers may exclusively allocate sets of data units from the data unit pool 540.2, so each data unit may only belong to one PID.

Each placement identifier may be connected to multiple reclaim unit handles at a next level of the group hierarchy. For example, first placement identifier 612.1 may connect to handles ranging from a first reclaim unit handle 614.1.1 to an nth reclaim unit handle 614.1.n. Similarly, nth placement identifier 612.n may connect to handles from a first reclaim unit handle 614.n.1 to an nth reclaim unit handle 614.n.n. In some configurations, the reclaim unit handles may correspond to endurance groups defined by the storage protocol. The reclaim unit handles may exclusively allocate sets of data units from the data unit pool 540.2, so each data unit may only belong to one RUH.

Reclaim unit handles may be further connected to reclaim groups (RGs) at a next level of the group hierarchy. For instance, first reclaim unit handle 614.1.1 may connect to reclaim groups ranging from a first reclaim group 616.1.1.1 to an nth reclaim group 616.1.1.n. This pattern may continue across all handles, with the nth reclaim unit handle in the nth placement identifier 614.n.n connecting to reclaim groups from a first reclaim group 616.n.n.1 to an nth reclaim group 616.n.n.n. The reclaim groups may be directly defined by the storage protocol and exclusively allocate sets of data units from the data unit pool 540.2, so each data unit may only belong to one RG.

At the lowest level of the hierarchy, each reclaim group may connect to multiple reclaim units (RUs). For example, first reclaim group 616.1.1.1 may connect to reclaim units ranging from a first reclaim unit 618.1.1.1.1 to an nth reclaim unit 618.1.1.1.n. This structure may continue throughout the hierarchy, with the nth reclaim group 616.n.n.n connecting to reclaim units up to an nth reclaim unit 618.n.n.n.n. The reclaim units may directly map to erase blocks in the non-volatile storage devices for data placement.

In some embodiments, the hierarchical identifiers in the global identifier hierarchy 600 may uniquely map the data units in a target namespace across the multiple data storage devices according to the multi-level hierarchy. This mapping may allow for flexible data placement and management across logical groups that may be isolated by the storage protocol, such as endurance groups and domains.

FIG. 7 depicts a master-child global identifier system 700 that may be implemented for NVMe-oF ecosystems. The master-child identifier system 700 is an example multi-level global identifier hierarchy that may show the relationship between master and child global identifiers as example multi-level global identifiers. The system may include a master global identifier 710 at the top level, which may connect to multiple child global identifiers ranging from a first child global identifier 712.1 to an nth child global identifier 712.n. In some configurations, the master global identifier 710 may correspond to a fabric adapter, such as fabric adapters 552.1-552.n in the multi-adapter host controller 550. Each child global identifier may correspond to a target subsystem, such as a JBOF or similar NVMe subsystem. Each child global identifier may connect to a global identifier hierarchy, represented by a first global identifier hierarchy 714.1 through an nth global identifier hierarchy 714.n. Each global identifier hierarchy 714 may be structured similarly to global identifier hierarchy 600 in FIG. 6.

Master-child identifier system 700 may allow for management of namespaces and data units across multiple fabric adapters and target subsystems. This configuration may enable the storage system 500 to support complex NVMe-oF deployments with multiple initiators and targets while maintaining flexible data placement capabilities across logically isolated groups.

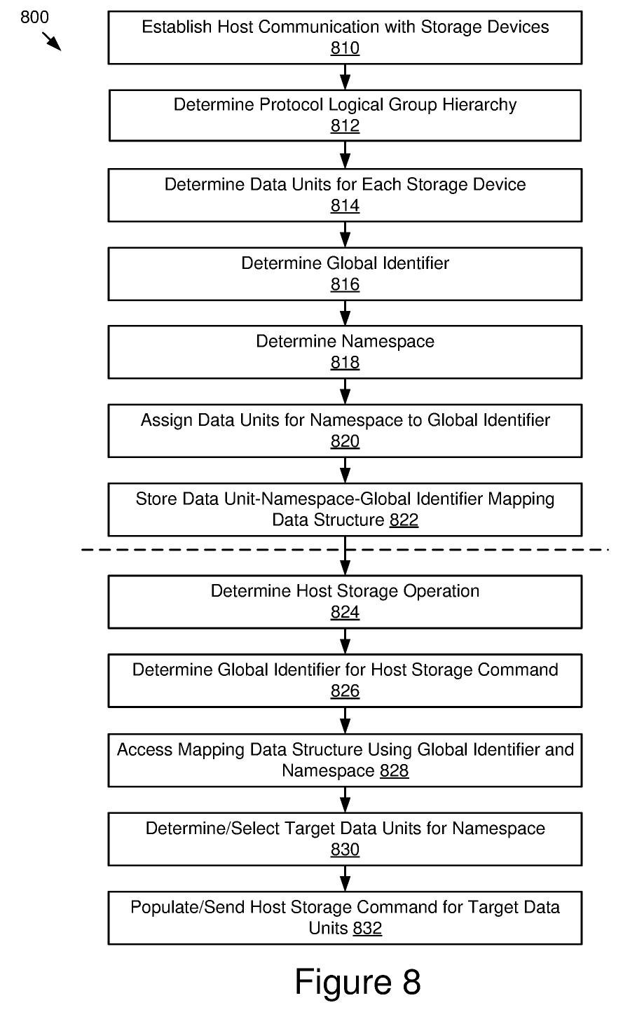

FIG. 8 illustrates a flowchart of a method 800 for managing data storage across multiple storage devices using global identifiers. Method 800 may be executed by components of a storage system, such as an NVMe initiator, a GID configuration manager, and/or a multi-adapter host controller. This method may establish a global identifier system for organizing and managing data units across multiple storage devices and namespaces, allowing for flexible data placement beyond traditional protocol-defined boundaries. By implementing this method, the storage system may enable more efficient resource allocation and improved system adaptability for host-managed data storage operations.

At block 810, communication may be established between a host system and storage devices using a storage protocol. For example, an NVMe initiator may initiate connections with multiple SSDs through a fabric network using NVMe.

At block 812, a protocol logical group hierarchy may be determined. For example, the GID configuration manager may analyze the storage protocol specifications to identify the structure of domains, endurance groups, and reclaim groups supported by the connected storage devices.

At block 814, data units for each storage device may be determined. For example, the system may query each connected SSD to obtain information about its available capacity and the organization of its data units, such as pages, blocks, or reclaim units, that form the device set of data units available on that SSD to be allocated among namespaces.

At block 816, a global identifier may be determined. For example, the GID configuration manager may generate a unique global identifier to represent a set of data units in a data pool in the data storage devices that can span across multiple logical groups in the storage system.

At block 818, a namespace may be determined. For example, the system may create or identify an existing namespace that will be associated with the global identifier and used for data storage operations.

At block 820, data units for the namespace may be assigned to the global identifier. For example, the GID configuration manager may allocate specific reclaim units from various endurance groups and domains to the namespace, associating them with the global identifier based on the logical group hierarchy supported by the storage protocol.

At block 822, a data unit-namespace-global identifier mapping data structure may be stored. For example, the system may create and populate a GID mapping table that records the relationships between groups of data units (defined by the logical group hierarchy), namespaces, and global identifiers across all storage devices, such as a matrix for each GID where each node of the matrix stores a data unit allocation value for that combination of data storage device and namespace.

Once any number of namespaces are defined and mapped in this manner, operations of method 800 may continue for the handling of individual host storage operations.

At block 824, a host storage operation may be determined. For example, the NVMe initiator may receive a read or write command from the host system targeting a specific namespace.

At block 826, a global identifier for a host storage command may be determined. For example, the NVMe initiator may receive or look up the appropriate global identifier associated with the target namespace of the host storage command.

At block 828, the mapping data structure may be accessed using the global identifier and namespace. For example, the NVMe initiator may query the GID mapping table corresponding to the GID to retrieve information about the data units associated with the target namespace.

At block 830, target data units for the namespace may be determined or selected. For example, based on the information from the mapping data structure, the system may identify specific reclaim units across multiple storage devices that are allocated to the target namespace and use data placement logic to select target data units for the storage operation from among the identified reclaim units.

At block 832, a host storage command for the target data units may be populated and sent. For example, the NVMe initiator may generate an NVMe command with the appropriate placement identifiers and reclaim unit handles corresponding to the domains and endurance groups to execute the storage operation on the selected data units across one or more storage devices, such as by adding the domain identifier, endurance group identifier, and data unit identifiers in corresponding parameter fields in the command.

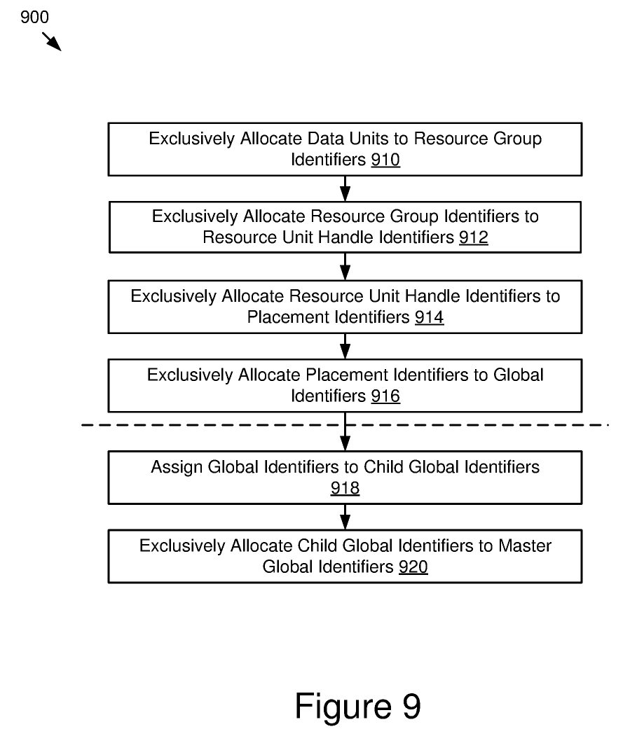

FIG. 9 illustrates a flowchart of a method 900 for allocating and organizing identifiers in a storage system hierarchy. Method 900 may be executed by components of a storage system, such as a GID configuration manager or a multi-adapter host controller. This method may establish a hierarchical structure for managing data units across multiple storage devices, logical groups, and namespaces using a series of exclusive allocations from the lowest level of resource groups up to the highest level of master global identifiers. By implementing this method, the storage system may create a flexible and scalable framework for data placement and management that spans across traditional protocol-defined boundaries.

At block 910, data units may be exclusively allocated to resource group identifiers. For example, the GID configuration manager may assign individual pages or erase blocks from SSDs to specific resource groups, ensuring that each data unit belongs to only one resource group.

At block 912, resource group identifiers may be exclusively allocated to resource unit handle identifiers. For example, the GID configuration manager may group multiple resource groups under a single resource unit handle, which may correspond to logically isolated endurance groups defined according to the storage protocol.

At block 914, resource unit handle identifiers may be exclusively allocated to placement identifiers. For example, the GID configuration manager may assign multiple resource unit handles to a placement identifier, which may correspond to logically isolated domains according to the storage protocol.

At block 916, placement identifiers may be exclusively allocated to global identifiers. For example, the GID configuration manager may group multiple placement identifiers under a single global identifier, allowing for the creation of namespaces that span across multiple endurance groups or domains.

In storage systems implementing GIDs across multiple initiators, such as host systems supporting multiple fabric adapters using NVMe-oF, method 900 may continue to define a master-child hierarchy over GID hierarchy defined in blocks 910-916 for each NVMe subsystem.

At block 918, global identifiers may be assigned to child global identifiers. For example, in a multi-adapter system, the host controller may create child global identifiers that represent subsets of the master global identifier corresponding to different target subsystems, storage arrays, or storage pools.

At block 920, child global identifiers may be exclusively allocated to master global identifiers. For example, the multi-adapter host controller may group multiple child global identifiers under a single master global identifier corresponding to the fabric adapter or NVMe initiator for reaching those target subsystems, providing a top-level management structure for the entire storage system that can span across multiple adapters and subsystems.

While at least one exemplary embodiment has been presented in the foregoing detailed description of the technology, it should be appreciated that a vast number of variations may exist. It should also be appreciated that an exemplary embodiment or exemplary embodiments are examples, and are not intended to limit the scope, applicability, or configuration of the technology in any way. Rather, the foregoing detailed description will provide those skilled in the art with a convenient road map for implementing an exemplary embodiment of the technology, it being understood that various modifications may be made in a function and/or arrangement of elements described in an exemplary embodiment without departing from the scope of the technology, as set forth in the appended claims and their legal equivalents.

As will be appreciated by one of ordinary skill in the art, various aspects of the present technology may be embodied as a system, method, or computer program product. Accordingly, some aspects of the present technology may take the form of an entirely hardware embodiment, an entirely software embodiment (including firmware, resident software, micro-code, etc.), or a combination of hardware and software aspects that may all generally be referred to herein as a circuit, module, system, and/or network. Furthermore, various aspects of the present technology may take the form of a computer program product embodied in one or more computer-readable mediums including computer-readable program code embodied thereon.

Any combination of one or more computer-readable mediums may be utilized. A computer-readable medium may be a computer-readable signal medium or a physical computer-readable storage medium. A physical computer readable storage medium may be, for example, but not limited to, an electronic, magnetic, optical, crystal, polymer, electromagnetic, infrared, or semiconductor system, apparatus, or device, etc., or any suitable combination of the foregoing. Non-limiting examples of a physical computer-readable storage medium may include, but are not limited to, an electrical connection including one or more wires, a portable computer diskette, a hard disk, random access memory (RAM), read-only memory (ROM), an erasable programmable read-only memory (EPROM), an electrically erasable programmable read-only memory (EEPROM), a Flash memory, an optical fiber, a compact disk read-only memory (CD-ROM), an optical processor, a magnetic processor, etc., or any suitable combination of the foregoing. In the context of this document, a computer-readable storage medium may be any tangible medium that can contain or store a program or data for use by or in connection with an instruction execution system, apparatus, and/or device.

Computer code embodied on a computer-readable medium may be transmitted using any appropriate medium, including but not limited to, wireless, wired, optical fiber cable, radio frequency (RF), etc., or any suitable combination of the foregoing. Computer code for carrying out operations for aspects of the present technology may be written in any static language, such as the C programming language or other similar programming language. The computer code may execute entirely on a user’s computing device, partly on a user’s computing device, as a stand-alone software package, partly on a user’s computing device and partly on a remote computing device, or entirely on the remote computing device or a server. In the latter scenario, a remote computing device may be connected to a user’s computing device through any type of network, or communication system, including, but not limited to, a local area network (LAN) or a wide area network (WAN), Converged Network, or the connection may be made to an external computer (e.g., through the Internet using an Internet Service Provider).

Various aspects of the present technology may be described above with reference to flowchart illustrations and/or block diagrams of methods, apparatus, systems, and computer program products. It will be understood that each block of a flowchart illustration and/or a block diagram, and combinations of blocks in a flowchart illustration and/or block diagram, can be implemented by computer program instructions. These computer program instructions may be provided to a processing device (processor) of a general purpose computer, special purpose computer, or other programmable data processing apparatus to produce a machine, such that the instructions, which can execute via the processing device or other programmable data processing apparatus, create means for implementing the operations/acts specified in a flowchart and/or block(s) of a block diagram.

Some computer program instructions may also be stored in a computer-readable medium that can direct a computer, other programmable data processing apparatus, or other device(s) to operate in a particular manner, such that the instructions stored in a computer-readable medium to produce an article of manufacture including instructions that implement the operation/act specified in a flowchart and/or block(s) of a block diagram. Some computer program instructions may also be loaded onto a computing device, other programmable data processing apparatus, or other device(s) to cause a series of operational steps to be performed on the computing device, other programmable apparatus or other device(s) to produce a computer-implemented process such that the instructions executed by the computer or other programmable apparatus provide one or more processes for implementing the operation(s)/act(s) specified in a flowchart and/or block(s) of a block diagram.

A flowchart and/or block diagram in the above figures may illustrate an architecture, functionality, and/or operation of possible implementations of apparatus, systems, methods, and/or computer program products according to various aspects of the present technology. In this regard, a block in a flowchart or block diagram may represent a module, segment, or portion of code, which may comprise one or more executable instructions for implementing one or more specified logical functions. It should also be noted that, in some alternative aspects, some functions noted in a block may occur out of an order noted in the figures. For example, two blocks shown in succession may, in fact, be executed substantially concurrently, or blocks may at times be executed in a reverse order, depending upon the operations involved. It will also be noted that a block of a block diagram and/or flowchart illustration or a combination of blocks in a block diagram and/or flowchart illustration, can be implemented by special purpose hardware-based systems that may perform one or more specified operations or acts, or combinations of special purpose hardware and computer instructions.

While one or more aspects of the present technology have been illustrated and discussed in detail, one of ordinary skill in the art will appreciate that modifications and/or adaptations to the various aspects may be made without departing from the scope of the present technology, as set forth in the following claims.

1. A system, comprising:
a storage interface configured for communication with a plurality of data storage devices using a storage protocol, wherein each data storage device of the plurality of data storage devices comprises a non-volatile storage medium configured to allocate data units to at least one namespace;
at least one processor configured to, alone or in combination:
determine, for each data storage device of the plurality of data storage devices, a device set of data units in that data storage device, wherein the device set of data units are configured to be allocated across a plurality of logically separated groups by the storage protocol;
determine a global identifier for at least one namespace in the plurality of data storage devices;
assign a namespace set of data units to the global identifier, wherein the namespace set of data units comprises data units from a plurality of logically separated groups;
determine, for a target namespace of the at least one namespace for a host storage command, a corresponding global identifier; and
send, based on the corresponding global identifier and through the storage interface, the host storage command targeting data units in the target namespace.

2. The system of claim 1, wherein the logically separated groups include at least one group defined by the storage protocol and selected from:
endurance groups configured to exclusively allocate a plurality of data units assigned to that endurance group; and
domains configured to exclusively allocate a plurality of endurance groups assigned to that domain.

3. The system of claim 2, wherein the storage protocol is configured to:
exclusively allocate each data unit in the plurality of data storage devices among a plurality of resource groups; and
exclusively allocate each resource group of the plurality of resource groups among a plurality of endurance groups.

4. The system of claim 1, further comprising:
a non-volatile memory configured to store a reference data structure comprising a matrix of:
data storage device identifiers corresponding to the plurality of data storage devices; and
namespace identifiers corresponding to the at least one namespace, wherein each node of the matrix stores a data unit allocation value for that combination of data storage device and namespace.

5. The system of claim 4, wherein:
the global identifier corresponds to a multi-level hierarchy of hierarchical identifiers corresponding to the logically separated groups; and
the data unit allocation value comprises at least one hierarchical identifier for each level of the multi-level hierarchy configured to uniquely map the data units in a target namespace across the plurality of data storage device according to the multi-level hierarchy.

6. The system of claim 5, wherein the data unit allocation value comprises:
a placement identifier corresponding to a domain defined by the storage protocol; and
a reclaim unit handle identifier corresponding to an endurance group defined by the storage protocol.

7. The system of claim 1, wherein:
the global identifier is configured to be a first global identifier in a first layer of a multi-level global identifier hierarchy; and
the first layer of multi-level global identifiers corresponds to namespace global identifiers mapped to a set of namespaces and data storage devices.

8. The system of claim 7, wherein the multi-level global identifier hierarchy further comprises:
master global identifiers corresponding to initiator systems defined by the storage protocol; and
child global identifiers corresponding to target subsystems defined by the storage protocol.

9. The system of claim 1, wherein the at least one processor is further configured to, alone or in combination:
determine a host storage operation for the host storage command;
access, using the global identifier and the target namespace, a reference data structure to determine at least one data unit allocation value and corresponding data storage device identifier;
select target data units for the host storage command; and
populate, in accordance with the storage protocol, the host storage command using the data unit allocation value and data unit identifiers for the target data units.

10. The system of claim 1, further comprising:
a network interface card configured for offloading the storage protocol from a host system and comprising:
the storage interface;
the at least one processor; and
a non-volatile memory configured to store a reference data structure mapping the global identifier to:
the at least one namespace;
the plurality of data storage devices; and
corresponding data path information for the storage protocol; and
a network switch configured to be communicatively coupled between the network interface card and the plurality of data storage devices.

11. A computer-implemented method, comprising:
establishing, through a storage interface, communication between a host system and a plurality of data storage devices using a storage protocol, wherein each data storage device of the plurality of data storage devices comprises a non-volatile storage medium configured to allocate data units to at least one namespace;
determining, for each data storage device of the plurality of data storage devices, a device set of data units in that data storage device, wherein the device set of data units are configured to be allocated across a plurality of logically separated groups by the storage protocol;
determining a global identifier for at least one namespace in the plurality of data storage devices;
assigning a namespace set of data units to the global identifier, wherein the namespace set of data units comprises data units from a plurality of logically separated groups;
determining, for a target namespace of the at least one namespace for a host storage command, a corresponding global identifier; and
send, based on the corresponding global identifier and through the storage interface, the host storage command targeting data units in the target namespace.

12. The computer-implemented method of claim 11, wherein the logically separated groups include at least one group defined by the storage protocol and selected from:
endurance groups configured to exclusively allocate a plurality of data units assigned to that endurance group; and
domains configured to exclusively allocate a plurality of endurance groups assigned to that domain.

13. The computer-implemented method of claim 12, wherein the storage protocol is configured to:
exclusively allocate each data unit in the plurality of data storage devices among a plurality of resource groups; and
exclusively allocate each resource group of the plurality of resource groups among a plurality of endurance groups.

14. The computer-implemented method of claim 11, further comprising:
storing, in a non-volatile memory, a reference data structure comprising a matrix of:
data storage device identifiers corresponding to the plurality of data storage devices; and
namespace identifiers corresponding to the at least one namespace, wherein each node of the matrix stores a data unit allocation value for that combination of data storage device and namespace; and
accessing the reference data structure to determine the data unit allocation value for sending the host storage command.

15. The computer-implemented method of claim 14, wherein:
the global identifier corresponds to a multi-level hierarchy of hierarchical identifiers corresponding to the logically separated groups; and
the data unit allocation value comprises at least one hierarchical identifier for each level of the multi-level hierarchy configured to uniquely map the data units in a target namespace across the plurality of data storage device according to the multi-level hierarchy.

16. The computer-implemented method of claim 15, wherein the data unit allocation value comprises:
a placement identifier corresponding to a domain defined by the storage protocol; and
a reclaim unit handle identifier corresponding to an endurance group defined by the storage protocol.

17. The computer-implemented method of claim 11, wherein:
the global identifier is configured to be a first global identifier in a first layer of a multi-level global identifier hierarchy; and
the first layer of multi-level global identifiers corresponds to namespace global identifiers mapped to a set of namespaces and data storage devices.

18. The computer-implemented method of claim 17, wherein the multi-level global identifier hierarchy further comprises:
master global identifiers corresponding to initiator systems defined by the storage protocol; and
child global identifiers corresponding to target subsystems defined by the storage protocol.

19. The computer-implemented method of claim 18, further comprising:
determining a host storage operation for the host storage command;
accessing, using the global identifier and the target namespace, a reference data structure to determine at least one data unit allocation value and corresponding data storage device identifier;
selecting target data units for the host storage command; and
populating, in accordance with the storage protocol, the host storage command using the data unit allocation value and data unit identifiers for the target data units.

20. A system comprising:
at least one processor;
at least one memory;
a storage interface configured for communication with a plurality of data storage devices using a storage protocol, wherein each data storage device of the plurality of data storage devices comprises a non-volatile storage medium configured to allocate data units to at least one namespace;
means for determining, for each data storage device of the plurality of data storage devices, a device set of data units in that data storage device, wherein the device set of data units are configured to be allocated across a plurality of logically separated groups by the storage protocol;
means for determining a global identifier for at least one namespace in the plurality of data storage devices;
means for assigning a namespace set of data units to the global identifier, wherein the namespace set of data units comprises data units from a plurality of logically separated groups;
means for determining, for a target namespace of the at least one namespace for a host storage command, a corresponding global identifier; and
means for send, based on the corresponding global identifier and through the storage interface, the host storage command targeting data units in the target namespace.
